(19) United States
(12) Patent Application Publication
(10) Pub. No.: US 2007/0218877 A1
(43) Pub. Date: Sep. 20, 2007

(54) PERSONAL RING BACK TONE

(75) Inventor: Kevin Michael Mills, San Antonio, TX (US)

Correspondence Address: ALCATEL LUCENT;INTELLECTUAL PROPERTY & STANDARDS, 3400 W. PLANO PARKWAY, MS LEGL2, PLANO, TX, 75075, US

(73) Assignee: ALCATEL, PARIS (FR)

(21) Appl. No.: 10/599,757

(22) PCT Filed: Apr. 7, 2005
(86) PCT No.: PCT/US05/11676

§ 371 Date: Oct. 6, 2006

Related U.S. Application Data
(60) Provisional application No. 60/560,189, filed on Apr. 7, 2004.

(51) Int. Cl. H04M 3/42

(52) U.S. Cl. 455/414.1

(57) ABSTRACT

A system, method, and computer readable medium for providing a personalized ring back tone comprises receiving a location request return result message (76) at a mobile switching center (24), based on the location request return result message (76), receiving an initial address message (78) at a personal ring back tone platform (12), based on the initial address message (78), receiving an address complete message with an optional backward call indicator parameter (80) at the mobile switching center (24), and providing the personalized ring back tone from the personal ring back tone platform (12) while normal call progress is occurring.

### CROSS-REFERENCE TO RELATED APPLICATIONS

The present invention is related to and claims priority from U.S. provisional patent application No. 60/560,189, filed on Apr. 7, 2004, titled RINGBACK TONE/PERSONAL CONNECTION TONE DELIVERY MECHANISM FOR IS41D NETWORKS, assigned to the assignee of the present invention, the entire contents of which are enclosed by reference herein.

### FIELD OF THE INVENTION

The present invention relates generally to ring back tones, and, more particularly, to a system, method, and computer readable medium for providing personal ring back tones.

### BACKGROUND OF THE INVENTION

The present invention describes a personal ring back tone or personalized connection tone (hereinafter referred to as personal ring back tone or personalized ring back tone) functionality whereby a customer (such as a wireless customer) can program custom ringing announcements or sounds (including tones, music, etc.) to be heard by a calling party. In general, the person who is calling the wireless customer would hear what the wireless customer intended them to hear instead of the normal ringing that would be heard. The problem that exists is that there is no industry standard or non-proprietary manner to allow for this service in existing networks (such as an IS41D network). More specifically, there is currently no way to connect a standard announcement platform and have normal call processing play a distinctive ring tone while the mobile phone itself is actually ringing.

Certain proprietary methods for delivering personal ring back tones exist but they involve utilizing custom processing in one or more network elements (such as a MSC) to bypass normal call processing and allow for the tone to be played while the network delivers the call to the mobile. There are also brute force methods whereby an announcement platform is placed directly “in front” of a wireless network, handles all calls to a wireless carrier, and selectively interrupts and performs ring back tone procedures where applicable. These approaches are very inefficient, cumbersome to operate and cost prohibitive.

Therefore, what is needed is a system, method, and computer readable medium for providing personal ring back tones that overcomes the problems and limitations described above.

### SUMMARY OF THE INVENTION

The present invention utilizes and enhances an IS41D feature to provide personalized ring back tones in an efficient manner. In one embodiment, a method for providing a personalized ring back tone comprises receiving a location request return result message at a mobile switching center (MSC), based on the location request return result message, receiving an initial address message (IAM) at a personal ring back tone platform, based on the IAM, receiving an address complete message (ACM) with an optional backward call indicator (OBCI) parameter at the MSC, and providing the personalized ring back tone from the personal ring back tone platform while normal call progress is occurring.

In another embodiment, a method for providing a ring back tone comprises receiving an IAM at a sound platform from a MSC, receiving an ACM with an optional backward call indicator parameter at the MSC from the sound platform, and providing the ring back tone from the sound resource platform.

In a further embodiment, a computer readable medium comprises instructions for receiving a first message at a first module from a second module, receiving a second message with an optional backward call indicator at the second module from the first module, and providing a ring back tone from the first module based on the received optional backward call indicator.

In yet another embodiment, a system for providing a personalized ring back tone comprises a MSC, and a personal ring back tone module operably coupled to the MSC, the personal ring back tone module adapted to accept at least one call leg of multiple call legs, request a voice channel to be opened, and play the personalized ring tone via the voice channel.

In yet a further embodiment, a communications switch is adapted to send a first call leg and a second call leg in parallel, wherein the first call leg connects a calling party to a personalized ring back tone, wherein the second call leg connects the calling party to a called party, and wherein the first call leg is released upon a connection of the second call leg.

In yet another embodiment, a personal ring back tone module is adapted to accept at least one call leg of multiple call legs, request a voice channel to be opened, and play the personalized ring tone via the voice channel.

### BRIEF DESCRIPTION OF THE DRAWINGS

FIG. 1 depicts a personalized ring back tone system in accordance with a preferred embodiment of the present invention;

FIG. 2 depicts an IS41D call flow;

FIG. 3 depicts a successful call flow for providing a personalized ring back tone in accordance with a preferred embodiment of the present invention;

FIG. 4 depicts a call flow in which a personalized ring back tone platform is not reachable in accordance with a preferred embodiment of the present invention; and

FIG. 5 depicts a call flow in which a default personalized ring back tone is played in accordance with a preferred embodiment of the present invention.

### DETAILED DESCRIPTION OF THE INVENTION

The present invention utilizes an IS41D feature that is widely supported, but advantageously includes a number of unique features that allows for an easy, efficient, and accurate network implementation of personalized ring back tone. This feature, known as Flexible Alerting, is designed to allow a Home Location Register (HLR) and a Mobile Switching Center (MSC) to cause multiple phones to ring at the same time.

The simplest (but not the only) manner in which to use Flexible Alerting would be to simply turn Flexible Alerting on (Single User Flexible Alerting list, per IS41D) for a customer and have their mobile number and a Public Switch Telephone Network (PSTN) routing number as the desired Flexible Alerting list. The PSTN number would be any number that would cause the MSC to connect to a personal ring back tone announcement platform. Automatically, the MSC will launch the call legs in parallel and attempt to connect to both the mobile and the PSTN number. At this point, the personal ring back tone announcement platform would acknowledge the call attempt, and start playing the wireless customer's desired personalized ring back tone based on the calling party. The call to the personal ring back tone announcement platform is never actually answered. In parallel, while the announcement platform is playing the tone, the MSC is also monitoring the leg where the actual mobile is ringing. The call leg that answers first is the “winner,” so the instant that the mobile answers the call from the called party, the call leg to the announcement platform is automatically released and the called party and the calling party are connected.

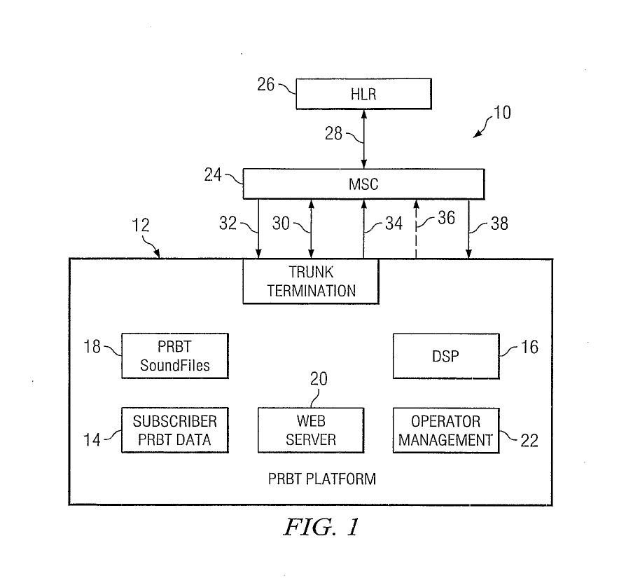

Referring now to FIG. 1, a personalized ring back tone system 10 of the present invention is depicted. The system 10 includes a personalized ring back tone platform 12, an MSC 24, and an HLR 26. The personalized ring back tone platform 12 (which may be a computer, a client, a server, or any electronic device capable of performing the related functionality described herein) includes a subscriber personalized ring back tone data module 14, at least one Digital Signal Processor (DSP) or other processor 16, a personalized ring back tone sound file module 18, a server (such as a web server) 20, and a management module (such as an operator management module) 22. The personalized ring back tone data module 14, the DSP 16, the personalized ring back tone sound file module 18, the server 20, and the management module 22 are preferably coupled via a bus (not shown) but may be connected directly or, for example, via a local area network.

The personalized ring back tone platform 12 and the MSC 24 are coupled via a connection 30 which is preferably a trunk or a trunk group (but may also include other wired and/or wireless connections) that terminates at the personalized ring back tone platform 12. The connection 30 preferably allows Integrated Services Digital Network (ISDN) User Part (ISUP) messages to be transferred between the personalized ring back tone platform 12 and the MSC 24. A connection 28 between the MSC 24 and the HLR 26 preferably allows ANSI/TCAP Wireless Intelligent Network (WIN) messages to be transferred between the MSC 24 and the HLR 26.

In general, utilizing Flexible Alerting, the HLR 26 sends multiple terminations to the MSC 24 in response to a location request (LOCREQ) message. The personalized ring back tone platform 12 is assigned a fixed, pseudo-PSTN phone number (for example, 999-888-7777) which allows for the platform 12 to be a terminating “phone” to all calls. As previously mentioned, Flexible Alerting designates the first number to actually answer the phone as the “winner,” thereby dropping the other terminations. The personalized ring back tone platform 12 never answers the phone, but instructs the MSC 24 to open a voice channel to allow the personalized ring back tone to play while the handset continues to ring. When the ringing handset is answered, or when voicemail picks up and sends an answer message (ANM), then the personalized ring back tone is automatically dropped. No further messaging is required and there is no tromboning through the personalized ring back tone platform 12 for the entire duration of the call.

More specifically, an Initial Address Message (IAM) 32 is received by the personalized ring back tone platform 12 from the MSC 24 via the connection 30. The subscriber personalized ring back tone data module 14 is then queried based on a called and a calling party in order to determine which personalized ring back tone to play. The personalized ring back tone sound files module 18 is accessed by the DSP 16 and is queued to play. The personalized ring back tone platform 12 then returns an Address Complete Message (ACM) 34 including an OptionalBackwardCallIndicators parameter (described further below) to the MSC 24 via the connection 30. If the OptionalBackwardCallIndicators parameter is not included in the ACM, an optional Call Progress (CPG) message 36 with the OptionalBackwardCallIndicators parameter is sent to the MSC 24 via the connection 30. The DSP 16 then starts the queued personalized ring back tone on the appropriate call leg until the MSC 24 sends a release (REL) message 38 to the personalized ring back tone platform 12 from the MSC 24 via the connection 30. The REL message 38 releases the trunks, for example, connecting the personalized ring back tone platform 12 and the MSC 24 and the personalized ring back tone is halted. A core portion of the present invention is the OptionalBackwardCallIndicators parameter that “forces” the MSC 24 to open the reverse voice path to allow a caller to hear the personalized ring back tone.

Various other embodiments of the system 10 are available without departing from the scope of the present invention. For example, a distributed personalized ring back tone platform is possible. In such a scenario, a sound resource platform (which could include the DSP 16 and the personalized ring back tone sound files module 18) and a content management system (which could include the subscriber's personalized ring back tones data module 14 or sound files identifier, the web server 20, and the operator management module 22) which is operably coupled to the sound resource platform, would form a core portion of the system. In either of the systems, the web server 20 is used, among other functionality, to permit internet access and to permit access to various sound files (that may be purchased from a content provider), while the operator management module 22 is used, among other functionality, to make various sound files available for purchase and to approve various sound files. After a sound file or personalized ring back tone is purchased, it is placed in the sound files module 18, and this information, along with other relevant information pertaining to tones to be played to particular calling parties or during a particular time of day, for example, is placed in the subscriber data module 14.

For both the system 10 depicted in FIG. 1 and the distributed system described above, access to the components of the system could occur in a variety of ways. For example, a user could access the components via the Internet or other data network, an SS7 network, a VoIP network, a computer, a telephone, in a wired or wireless manner, and/or a combination of these access capabilities. Further, various content providers and sound file catalogs can provide the personalized ring back tones and other data, voice, and multimedia files to the personalized ring back tone platform based on a users selection.

Although one personalized ring back tone platform 12, MSC 24 and HLR 26 are depicted in FIG. 1, a plurality of platforms 12, MSCs 24, HLRs 26, and other components can be utilized without departing from the scope of the present invention. Further, the system 10 can include an inter-system termination (where an originating MSC and a terminating MSC are different) or a local termination (where an originating MSC and a terminating MSC are the same). In either situation, the Flexible Alerting logic would be unchanged, however, the HLR would return a different result (which will be described below in further detail).

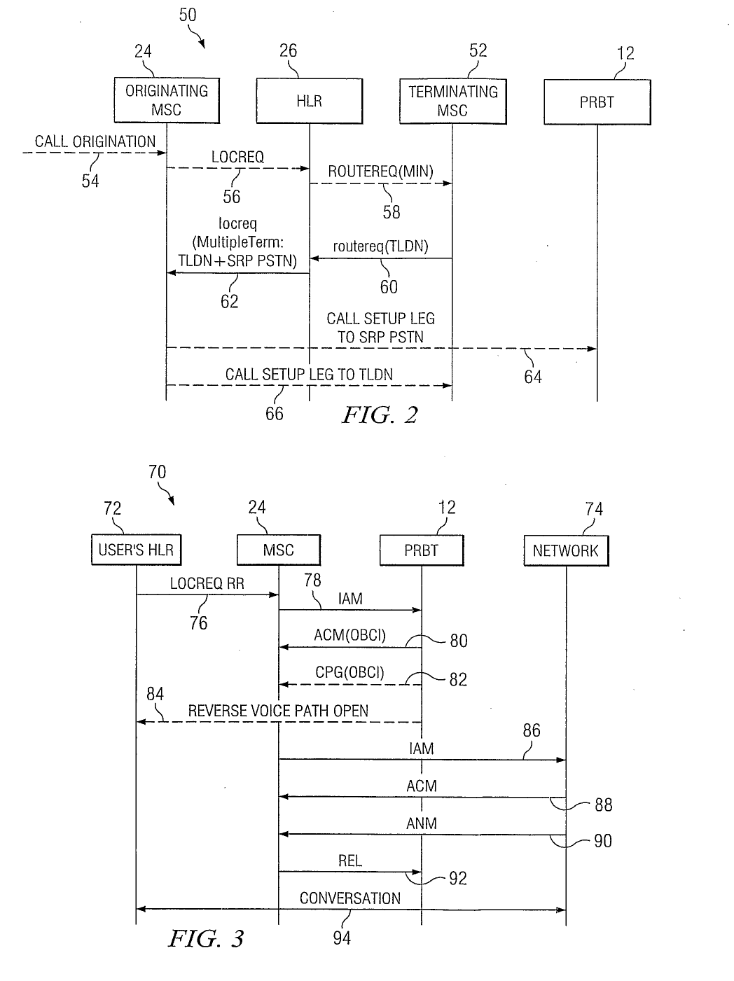

Referring now to FIG. 2, a message flow 50 depicting Flexible Alerting is presented. A call origination message 54 is received at an MSC 24 which then sends a location request (LOCREQ) message 56 to an HLR 26. The HLR 26 then sends a route request (ROUTEREQ) message with a mobile identification number (MIN) parameter 58 to a terminating MSC 52. In response to the message 58, the terminating MSC 52 sends a route request (routereq) message with a temporary local directory number (TLDN) 60 to the HLR 26 which returns the TLDN (or LocalTermination) plus the personalized ring back tone platform 12 or sound resource platform PSTN routing number 62 that causes the MSC 24 to route a leg of the call 64 to the personalized ring back tone platform 12. A leg of the call is then setup 66 between the MSC 24 and the MSC 52.

In one embodiment of the present invention, a system for providing a personalized ring back tone comprises an MSC and a personal ring back tone module operably coupled to the MSC, wherein the personal ring back tone module is adapted to: accept at least one call leg of multiple call legs, request a voice channel to be opened, and play the personalized ring tone via the voice channel, wherein the module includes identifiers to a called party's sound files, and wherein the module receives an indication of the calling party form the MSC and based on the indication, provides a sound file identifier. The personalized ring tone is played to a calling party based on the received sound file identifier, wherein a second call leg of the multiple call legs is used to attempt a connection to a mobile number, wherein the personalized ring tone is played while the connection to the mobile number is attempted, and wherein the personalized ring tone is stopped when the connection to the mobile number is successful.

In another embodiment of the present invention, a communications switch is adapted to: send a first call leg and a second call leg in parallel, wherein the first call leg connects a calling party to a personalized ring back tone, wherein the second call leg connects the calling party to a called party, and wherein the first call leg is released upon a connection of the second call leg. The connection to the personalized ring back tone is based on a received optional backward call indicator parameter, wherein the release is based on a received answer message, and wherein the switch is at least one of a mobile switching center or an internet protocol based switch.

Various requirements for the MSC 24 may exist. For example, ISUP support for Optional Backward Call Indicators within the ACM will probably be necessary. To support the personalized ring back tone feature, the personalized ring back tone platform 12 should use ISUP to force a voice path open through the network from the platform 12 call leg to a calling party. This will be accomplished using the ISUP optional parameter ‘Optional Backward Call Indicators’ which is contained in the ACM the personalized ring back tone platform 12 returns to the MSC 24 for that call leg. The Optional Backward Call Indicators parameter includes an Inband Information Indicator (with an available Bit A=1 indicating Inband Information or an appropriate pattern) and a User-Network Interaction Indicator (with an available Bit H=1 indicating a cut through in both directions when user network interaction occurs). Due to differences in an MSC implementation, the personalized ring back tone platform 12 may be required to send bit A=1 and/or bit H=1. Therefore, in accordance with the present invention, this selection is preferably configurable within the platform 12.

In place of utilizing the Optional Backward Call Indicators within the ACM, another requirement for the MSC 24 may include ISUP support for Optional Backward Call Indicators within Call Progress Message (CPG). An optional requirement of the MSC is support of the ISUP CPG message. This message can be used following the ACM from the personalized ring back tone platform 12 to force open the personalized ring back tone reverse voice path. This message can be used on MSCs that are not compliant to a point where the Optional Backward Call Indicators are included in the ACM. Whereas the ACM is primarily used to indicate that call routing is proceeding (with the event notification being a subprocess), the CPG message is specifically used to notify that an event has occurred in the handling of this call. It is important to note that the platform 12 can be configured to use the CPG message instead of including the OBCI parameters in the ACM if required or desired. As indicated above, and due to differences in an MSC implementation, the personalized ring back tone platform 12 may be required to send bit A=1 and/or bit H=1. Therefore, in accordance with the present invention, this selection is preferably configurable within the platform 12. The Optional Backward Call Indicator includes at least one of: an element header, an in-band information indicator=1, a call forward may occur indicator, a simple segmentation indicator, a network excessive delay indicator, a user-network interaction indicator=1, a MLPP user indicator, spare bits, or reserved bits.

A further requirement for the MSC 24 may include an Original Dialed Number in the IAM for the PSTN call leg arriving at the personalized ring back tone platform 12. Typically, the MSC will include the OriginalCalledNumber parameter in the PSTN IAM for billing purposes (within the OriginalCalledNumber field or RedirectingNumber field). It is mandatory that the PSTN call leg have these digits (the Subscriber B Number) in the PSTN IAM call leg so that the personalized ring back tone service can function. If not normally included, then the MSC configuration should be changed to include the B number in any MSC preferred parameter, inside the IAM message. Such parameters, which can be populated by the MSC to allow for personalized ring back tone include, but are not limited to, ChargeNumber, GenericDigits, and the aforementioned OriginalCalledNumber, and RedirectingNumber.

Referring now to FIG. 3, a successful call flow 70 for providing a personalized ring back tone is depicted (with multiple call legs shown). A user's HLR 72, sends a location request return result (LOCREQ RR) message 76 to an MSC 24 which sends an IAM 78 to the personalized ring back tone platform 12. The platform 12 responds with an ACM including an OBCI parameter 80, or, optionally, responds with a CPG message including the OBCI parameter 82. This message 82 is sent from the personalized ring back tone platform 12 to the MSC 24 after an ACM without an OBCI parameter is returned. At this point a personalized ring back tone leg is created between the calling party device and the platform 12.

A reverse voice path is opened 84 from the platform 12 to a user's device and a desired or applicable personalized ring back tone begins to play. If an IAM 86 is sent to the network 74, which may include another MSC and/or HLR servicing a called user device, an ACM 88 is sent to the MSC 24, followed by an ANM 90. At this point, a call leg has been created from the MSC 24 to the called party device that begins to ring, and eventually goes off-hook. The connection between the MSC 24 and the personalized ring back tone platform 12 is released 92, the personalized ring back tone stops playing, and the call legs are joined 94 resulting in conversation or other activity via the calling party device and the called party device.

Table 1 below includes the parameters associated with the Address Complete Message (ACM) which is sent in the backward direction indicating that all the address signals required for routing the call to the called party have been received:

TABLE 1

| Parameters | Status | Notes |
|---|---|---|
| Message Type | Mandatory | The message type code consists of a one octet |
| | | field and is mandatory. |
| Access Transport | Optional | |
| Application Transport | Optional | |
| Backward Call Indicators | Mandatory | Information sent in the backward direction |
| | | consisting of the charge indicator, called |
| | | party's status indicator, end-to-end information |
| | | indicator, ISDN User Part indicator, holding |
| | | indicator, ISDN access indicator, echo control |
| | | device indicator, and SCCP method indicator. |
| Business Group | Optional | |
| Call Reference | Optional | |
| Cause Indicators | Optional | |
| Connection Request | Optional | |
| Information Indicators | Optional | |
| Network Transport | Optional | |
| Notification Indicator | Optional | |
| OPT. Backward Call Indicators | Optional | |
| Redirect Status | Optional | |
| Redirection Information | Optional | |
| Remote Operations | Optional | |
| Service Activation | Optional | |
| Transmission Medium Used | Optional | |
| User-to-User Indicators | Optional | |
| User-to-User Information | Optional | |

Table 2 below includes the parameters associated with the Answer Message (ANM) which is sent in the backward direction indicating that the call has been answered:

TABLE 2

| Parameters | Status | Notes |
|---|---|---|
| Message Type | Mandatory | The message type code consists of a one octet |
| | | field and is mandatory. |
| Access Transport | Optional | |
| Application Transport | Optional | |
| Backward Call Indicators | Optional | |
| Business Group | Optional | |
| Call Reference | Optional | |
| Connection Request | Optional | |
| Information Indicators | Optional | |
| Network Transport | Optional | |
| OPT. Backward Call Indicators | Optional | Indicates that this call leg has a valid |
| | | announcement to be played to the calling party. |
| Redirect Status | Optional | |
| Remote Operations | Optional | |
| Service Activation | Optional | |
| Transmission Medium Used | Optional | |
| User-to-User Indicators | Optional | |
| User-to-User Information | Optional | |

Table 3 below includes the parameters associated with the Initial Address Message (IAM) which is sent in the forward direction to initiate seizure of an outgoing circuit and to transmit number and other information relating to the routing and handling of a call:

TABLE 3

| Parameters | Status | Notes |
|---|---|---|
| Message Type | Mandatory | The message type code consists of a one octet |
| | | field and is mandatory. |
| Access Transport | Optional | |
| Application Transport | Optional | |
| Business Group | Optional | |
| Call Reference | Optional | |
| Called Party Number | Mandatory | This will be the SRP PSTN phone number as |
| | | applied during FA provisioning in the HLR |
| Charge Number | Optional | Could be used to contain the original B number |
| Calling Geodetic Location | Optional | |
| Calling Party Number | Optional | This will contain the calling party and will |
| | | consist of the odd/even indicator, nature of |
| | | address indicator, numbering plan indicator, |
| | | and address signals. The digits shall contain |
| | | the original calling party information. |
| Calling Party's Category | Mandatory | Information sent in the forward indicating the |
| | | category of the calling party, e.g., ordinary |
| | | subscriber, test call. |
| Carrier Identification | Optional | |
| Carrier Selection Information | Optional | |
| Carrier Service Provider Identification | Optional | |
| Circuit Assignment Map | Optional | |
| Connection Request | Optional | |
| Egress Service | Optional | |
| Forward Call Indicators | Mandatory | Information sent in the forward direction |
| | | consisting of the incoming international call |
| | | indicator, end-to-end method indicator, |
| | | interworking indicator, end-to-end information |
| | | indicator, ISDN User Part indicator, ISDN User |
| | | Part preference indicator, ISDN access |
| | | indicator, and SCCP method indicator. |
| Generic Address | Optional | The Generic Address may contain MSRN in |
| | | the cases that MSRN was not provided in the |
| | | Called Number parameter. |
| Generic Digits | Optional | Could be used to contain the original B number |
| Generic Name | Optional | |
| Geodetic Loc Para | Optional | |
| HOP Counter | Optional | |
| Information Request Indicators | Optional | |
| Jurisdiction Information | Optional | |
| Nature Of Connection Indicators | Mandatory | Information sent in the forward direction |
| | | consisting of the satellite indicator, continuity |
| | | check indicator, and echo control device |
| | | indicator. |
| Network Management Controls | Optional | |
| Network Transport | Optional | |
| Network Specific Facility Parameter | Optional | |
| Operator Services Information | Optional | |
| Original Called Number | Optional | The original called number (B Number) may be |
| | | provided in this parameter. |
| OPT. Forward Call Indicators | Optional | |
| Originating Line Information | Optional | |
| Pivot Capability | Optional | |
| Precedence | Optional | |
| Redirect Capability | Optional | |
| Redirect Counter | Optional | |
| Redirect Forward Information | Optional | |
| Redirection Information | Optional | |
| Redirecting Number | Optional | Could be used to contain the original B number |
| Remote Operations | Optional | |
| Service Activation | Optional | |
| Service Code | Optional | |
| Special Processing Request | Optional | |
| Transaction Request | Optional | |
| Transit Network Selection | Optional | |
| User Service Information | Mandatory | Information sent in the forward direction |
| | | indicating the bearer capability requested by |
| | | the calling party and including as a minimum |
| | | the coding standard, information transfer |
| | | capability, transfer mode, and information |
| | | transfer rate. |
| User Service Information Prime | Optional | |
| User-to-User Information | Optional | |

Table 4 below includes the parameters associated with the Call Progress (CPG) message which is sent in the forward or backward direction indicating that an event has occurred in the progress of the call:

TABLE 4

| Parameters | Status | Notes |
|---|---|---|
| Message Type | Mandatory | The message type code consists of a one octet |
| | | field and is mandatory. |
| Access Transport | Optional | |
| Backward Call Indicators | Optional | |
| Business Group | Optional | |
| Call Reference | Optional | |
| Cause Indicators | Optional | |
| Event Information | Mandatory | |
| Information Indicator | Optional | |
| Network Transport | Optional | |
| Notification Indicator | Optional | |
| Operator Services Information | Optional | |
| Optional Backward Call Indicators | Optional | Sent in upstream path to open reverse voice |
| | | path back to caller |
| Redirecting Number | Optional | Could be used to contain the original B number |
| Remote Operations | Optional | |
| Service Activation | Optional | |
| Transit Medium Used | Optional | |
| User Service Information Prime | Optional | |
| User-to-User Information | Optional | |

Table 5 below includes the parameters associated with the Release (REL) message which is sent in either direction indicating that the circuit identified in the message is being released due the reason (cause) supplied and is ready to be put in the idle state on receipt of the Release Complete (RLC) message:

TABLE 5

| Operation | Status | Notes |
|---|---|---|
| Message Type | Mandatory | The message type code consists of a one octet |
| | | field and is mandatory. |
| Access Transport | Optional | |
| Automatic Congestion Level | Optional | |
| Call Reference | Optional | |
| Charge Number | Optional | |
| Cause Indicators | Mandatory | Information sent in either direction consisting |
| | | of the coding standard, location, cause value |
| | | and diagnostics. It indicates the reason for |
| | | sending the message in which it is contained, |
| | | e.g., the Release, Address complete or |
| | | Confusion messages, and identifies the network |
| | | in which the message originated, e.g., local |
| | | network, transit network, remote local network. |
| Generic Address | Optional | |
| Redirect Backward Information | Optional | |
| Redirection Number | Optional | |
| Service Activation | Optional | |
| User-to-User Information | Optional | |

Table 6 below includes the parameters associated with the Release Complete (RLC) message which is sent in either direction in response to the receipt of a Release Message, or if appropriate, to a Reset Circuit Message, when the circuit concerned has been brought into the idle condition:

TABLE 6

| Operation | Status | Notes |
|---|---|---|
| Message Type | Mandatory | The message type code |
| | | consists of a one octet |
| | | field and is mandatory. |

In one embodiment of the present invention, a method for providing a personalized ring back tone comprises receiving a location request return result message at a MSC, based on the location request return result message, receiving an IAM at a personal ring back tone platform, based on the IAM, receiving an ACM with an optional backward call indicator parameter at the MSC, and providing the personalized ring back tone from the personal ring back tone platform while normal call progress is occurring (to the called party), wherein the location request message is sent by a user's HLR, wherein the personalized ring back tone is provided to the device, and wherein the personalized ring back tone is provided via an open reverse voice path between the personal ring back tone platform and the device.

If the ACM is received without the optional backward call indicator parameter, the method continues by receiving a call progress message with an optional backward call indicator parameter at the MSC and providing the personalized ring back tone from the personal ring back tone platform based on the received call progress message. A release message is eventually sent from the MSC to the personal ring back tone platform, wherein the personalized ring back tone is no longer provided based on at least one of: the received release message or the ANM, wherein the calling party device is joined with a called party device, and wherein the called party device is associated with the ANM.

In another embodiment of the present invention, a method for providing a ring back tone comprises receiving an IAM at a sound platform from a MSC, receiving an ACM with an optional backward call indicator parameter at the MSC from the sound platform, and providing the ring back tone from the sound platform, wherein the ring back tone is received by a device associated with the IAM, and wherein the ring back tone is based on at least one of: a called party, a called party number, a called party device, a calling party, a calling party number, a calling party device, a time of day, a day of the year, or a location.

In a further embodiment of the present invention, a computer readable medium comprises instructions for receiving a first message (such as an IAM) at a first module (such as the platform 12) from a second module (such as the MSC 24), receiving a second message (such as an ACM) with an Optional Backward Call Indicator at the second module from the first module, and providing a ring back tone from the first module based on the received optional backward call indicator.

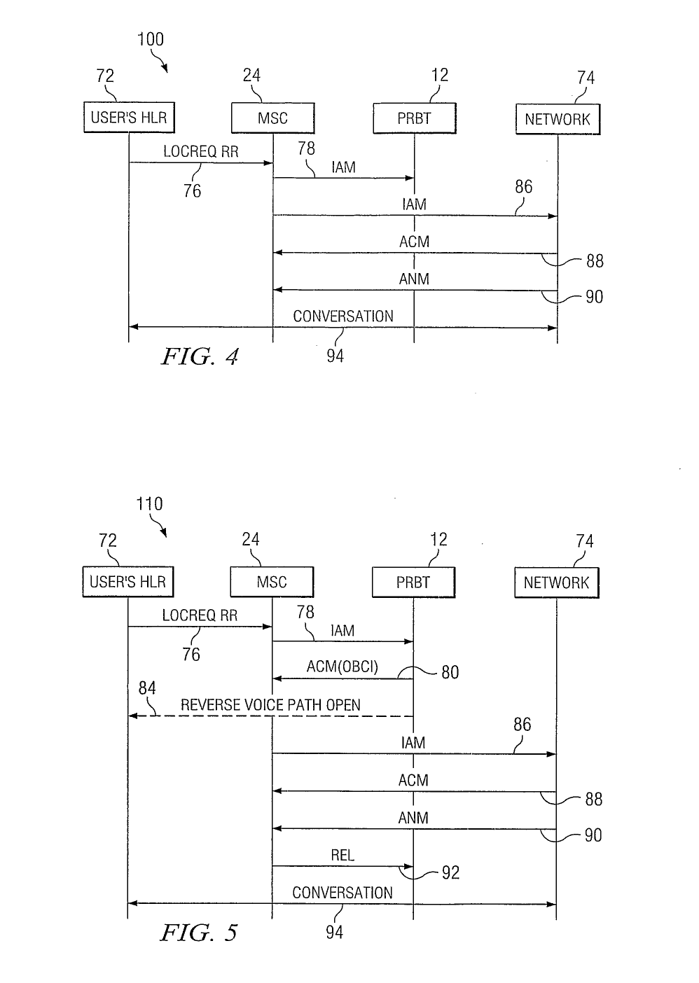

Referring now to FIG. 4, a call flow 100 in which the personalized ring back tone platform 12 is not reachable is depicted (with multiple call legs shown). A user's HLR 72 sends a location request return result (LOCREQ RR) message 76 to an MSC 24 which sends an IAM 78 to the personalized ring back tone platform 12. If the platform 12 does not answer the IAM 78, an IAM 86 is sent to the network 74, which may include another MSC and/or HLR servicing a called user device, an ACM 88 is sent to the MSC 24, followed by an ANM 90. At this point, a call leg has been created from the MSC 24 to the called party device that begins to ring, and eventually goes off-hook (answered), and the call legs are joined 94 resulting in conversation or other activity via the calling party device and the called party device.

Referring now to FIG. 5, a call flow 110 in which a default personalized ring back tone is played is depicted (with multiple call legs shown). A user's HLR 72, sends a location request return result (LOCREQ RR) message 76 to an MSC 24 which sends an IAM 78 to the personalized ring back tone platform 12. The platform 12 responds with an ACM including an OBCI parameter 80. At this point a personalized ring back tone leg is created between the calling party device and the platform 12.

A reverse voice path is opened 84 from the platform 12 to the user's device and a default ring back tone begins to play. If an IAM 86 is sent to the network 74, which may include another MSC servicing a called user device, an ACM 88 is sent to the MSC 24, followed by an ANM 90. At this point, a call leg has been created from the MSC 24 to the called party device that begins to ring, and eventually goes off-hook/is answered. The connection between the MSC 24 and the personalized ring back tone platform 12 is released 92, the personalized ring back tone stops playing, and the call legs are joined 94 resulting in conversation or other activity via the calling party device and the called party device.

The present invention allows for a very efficient use of resources in a network, minimal routing and hardware changes in a network, provides for optimal routing, and scales very easily. Utilizing the Flexible Alerting message in the unique manner described in the present invention instead of its original intended purpose (to make multiple real phone ring), and to have one of the destinations be an announcement platform or personalized ring back tone platform is ideal. Various advantages of the present invention include: allowing multiple call legs to occur with as little proprietary implementation as possible, allowing a voice path to open without starting charging for a call, allowing typically required changes in both the HLR and MSC, or the MSC and SCP to occur with different vendors, providing a feature that does not require custom development, allowing easy scaling because each announcement platform or personalized ring back tone platform is designated a phone number and as usage grows, a service provider may simply add another announcement platform with a new number, and assigns new personalized ring back tone subscribers to the ‘new’ phone number, and not requiring proprietary signaling software to be present in an MSC.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the system 10 can be performed by one or more of the modules or components described herein or in a distributed architecture. For example, all or part of the personalization ring back tone platform 12, or the functionality associated with the platform 12 may be included within or co-located with an MSC. Further, the functionality described herein may be performed at various times and in relation to various events, internal or external to the modules or components. Also, the information sent between various modules (including the personalized ring back tone platform 12, the subscriber personalized ring back tone data module 14, the processor 16, the personalized ring back tone sound file module 18, the server 20, the management module 22, the 2MSC 24, and the HLR 26), can be sent between the modules via at least one of a data network, the Internet, a voice network, an Internet Protocol network, a wireless source, a wired source and/or via plurality of protocols.

What is claimed is:

1. A method for providing a personalized ring back tone, comprising:
receiving a location request return result message at a mobile switching center (MSC);
based on the location request return result message, receiving an initial address message (IAM) at a personal ring back tone platform;
based on the IAM, receiving an address complete message (ACM) with an optional backward call indicator parameter at the MSC; and
providing the personalized ring back tone from the personal ring back tone platform while normal call progress is occurring.

2. The method of claim 1, wherein the location request message is sent by a user's HLR.

3. The method of claim 2, wherein the personalized ring back tone is provided to a user's device.

4. The method of claim 3, wherein the personalized ring back tone is provided via an open reverse voice path between the personal ring back tone platform and the device.

5. The method of claim 1 comprising, if the ACM is received without the optional backward call indicator parameter, receiving a call progress message with an optional backward call indicator parameter at the MSC.

6. The method of claim 4 comprising providing the personalized ring back tone from the personal ring back tone platform based on the received call progress message.

7. The method of claim 2 comprising receiving an IAM from the MSC to a terminating network.

8. The method of claim 7 comprising receiving an ACM from the terminating network to the MSC.

9. The method of claim 8 comprising receiving an answer message (ANM) from the terminating network to the MSC.

10. The method of claim 9 comprising receiving a release message from the MSC to the personal ring back tone platform.

11. The method of claim 10, wherein the personalized ring back tone is no longer provided based on at least one of: the received release message or the ANM.

12. The method of claim 10, wherein the calling party device is joined with a called party device.

13. The method of claim 12, wherein the called party device is associated with the ANM.

14. The method of claim 7, wherein the terminating network includes the MSC.

15. The method of claim 7, wherein the terminating network includes another MSC.

16. The method of claim 1, wherein the optional backward call indicator includes at least one of:
an element header;
an in-band information indicator=1;
a call forward may occur indicator;
a simple segmentation indicator;
a network excessive delay indicator;
a user-network interaction indicator=1;
a MLPP user indicator;
spare bits; or
reserved bits.

17. A method for providing a ring back tone, comprising:
receiving an initial address message (IAM) at a sound platform from a mobile switching center (MSC);
receiving an address complete message (ACM) with an optional backward call indicator parameter at the MSC from the sound platform; and
providing the ring back tone from the sound platform.

18. The method of claim 17, wherein the ring back tone is received by a device associated with the IAM.

19. The method of claim 18, wherein the ring back tone is based on at least one of: a called party, a called party number, a called party device, a calling party, a calling party number, a calling party device, a time of day, a day of the year, or a location.

20. A computer readable medium comprising instructions for:
receiving a first message at a first module from a second module;
receiving a second message with an optional backward call indicator at the second module from the first module; and
providing a ring back tone from the first module based on the received optional backward call indicator.

21. A system for providing a personalized ring back tone, comprising:
a mobile switching center (MSC); and
a personal ring back tone module operably coupled to the MSC, the personal ring back tone module adapted to:
accept at least one call leg of multiple call legs;
request a voice channel to be opened; and
play the personalized ring tone via the voice channel.

22. The system of claim 21, wherein the module includes identifiers to a called party's sound files.

23. The system of claim 22, wherein the module receives an indication of the calling party form the MSC and based on the indication, provides a sound file identifier.

24. The system of claim 23, wherein the personalized ring tone is played to a calling party based on the received sound file identifier.

25. The system of claim 21, wherein a second call leg of the multiple call legs is used to attempt a connection to a mobile number.

26. The system of claim 25, wherein the personalized ring tone is played while the connection to the mobile number is attempted.

27. The system of claim 26, wherein the personalized ring tone is stopped when the connection to the mobile number is successful.

28. A communications switch adapted to:
send a first call leg and a second call leg in parallel;
wherein the first call leg connects a calling party to a personalized ring back tone;
wherein the second call leg connects the calling party to a called party; and
wherein the first call leg is released upon a connection of the second call leg.

29. The communications switch of claim 28, wherein the connection to the personalized ring back tone is based on a received optional backward call indicator parameter.

30. The communications switch of claim 28, wherein the release is based on a received answer message.

31. The communications switch of claim 28, wherein the switch is at least one of a mobile switching center or an internet protocol based switch.

32. A personal ring back tone module adapted to:
accept at least one call leg of multiple call legs;
request a voice channel to be opened; and
play the personalized ring tone via the voice channel.
